(19) United States
(12) Patent Application Publication
(10) Pub. No.: US 2008/0254856 A1
(43) Pub. Date: Oct. 16, 2008

(54) Slot machine with circular sections and method

(75) Inventor: Kazumasa Yoshizawa, Tokyo (JP)

Correspondence Address: ARENT FOX LLP, 1050 CONNECTICUT AVENUE, N.W., SUITE 400, WASHINGTON, DC, 20036, US

(73) Assignee: Aruze Corp.

(21) Appl. No.: 11/882,661

(22) Filed: Aug. 3, 2007

(30) Foreign Application Priority Data
Aug. 7, 2006 (JP) 2006-214715

(51) Int. Cl. A63F 13/00

(52) U.S. Cl. 463/20

(57) ABSTRACT

A slot machine includes a display device and a controller. The display device dynamically and statically displays circular sections aligned in coaxial circles with different radii. Each section displays game symbols. The controller is configured with the logic to: (a) determine a circular sector coaxial with the coaxial circles as a valid area; (b) control the display device to display the valid area and other areas in different colors; (c) control the display device to display the circular sections in a rotational motion around an axis aligned with the center of the coaxial circles, in response to an instruction for starting a game given by a player; (d) control the display device to statically display the rotationally displayed circular sections; and (e) provide an award to the player when the display device has statically displayed predetermined symbols on a predetermined number of the circular sections within the valid area.

This application is based on and claims the benefit of priority from Japanese Patent Application No. 2006-214715, filed on 7 Aug. 2006, the content of which is incorporated herein by reference.

### BACKGROUND OF THE INVENTION

1. Field of the Invention

The invention relates to a slot machine, and more particularly, relates to a slot machine played by a player through inserting coins and the like, and a method for controlling the slot machine.

2. Related Art

Slot machines have conventionally been equipped with a plurality of sections (reels), each section displaying a plurality of symbols, so as to form a matrix (e.g., three columns by three rows). The sections start rotating in response to the insertion of a predetermined number of coins, followed by an action applied to a start lever by a player.

The sections start rotating in response to the start lever manipulated by the player, and come to rest after a predetermined number of rotations (a predetermined elapse of time). The slot machines pay out a number of coins according to the combination of the symbols lying on a pay line.

The pay line (line associated with the payment of coins) described above has been typically a straight line. However, a slot machine with a non-straight line as well as a straight line for a pay line will be introduced in order to add a new dimension to the game. A slot machine having a non-straight line as a pay line employs a straight section to display a symbol. Such a type of slot machine is disclosed in Patent Document No. 1.

Patent Document No. 1: U.S. Pat. No. 5,580,053

However, as shapes of pay lines have become more complicated, it tends to be more difficult for a player to identify the pay lines, although the game provides versatile aspects for enjoying the game. In the above case, there is a need for a slot machine which employs a new shape of section instead of the straight section.

### SUMMARY OF THE INVENTION

The present invention provides a slot machine including a display device and a controller. The display device dynamically and statically displays a plurality of circular sections aligned in coaxial circles with different radii. Each section displays a plurality of game symbols. The controller is configured with the logic to: (a) determine a circular sector coaxial with the coaxial circles as a valid area; (b) control the display device to display the valid area and areas other than the valid area in different colors; (c) control the display device to display the circular sections in a rotational motion around an axis aligned with the center of the coaxial circles, in response to an instruction for starting a game given by a player; (d) control the display device to statically display the rotationally displayed circular sections; and (e) provide an award to the player when the display device has statically displayed predetermined symbols on a predetermined number of the circular sections within the valid area.

As described above, the display device of the slot machine displays the plurality of circular sections aligned in the coaxial circles with different radii and the valid area shaped in a circular sector coaxial with the coaxial circles in different colors. The controller controls the display device to rotationally and statically display the circular sections around the axis aligned with the center of the coaxial circles, and provides the award to the player when the display device has statically displayed the predetermined symbols on the predetermined number of the circular sections within the valid area.

The slot machine according to the present invention provides a game with a new type of display, in which the circular sections are aligned in the coaxial circles with different radii, differing from the conventional linear-type display. This allows the player to merely comprehend the valid area during the game, freeing the player from having to understand complicated pay lines. Since the display displays the valid area distinguished from the circular sections, the player can intuitively identify the valid area. Since the present invention enables the player to enjoy a novel and unconventional game, while he or she can easily follow the proceedings of the game, it can increase the enjoyment factor of the game.

According to the present invention, it may be possible that the controller controls the display device to rotationally display at least one of the circular sections in a predetermined direction, and other sections in the opposite direction.

In this way, the display device rotationally displays at least one of the circular sections in the predetermined direction, and other sections in the opposite direction. Since the player can enjoy an unconventional type of game, in which the circular sections are rotationally displayed in different directions, the slot machine according to the present invention can increase the enjoyment factor of the game.

According to the present invention, it may further be possible that the controller controls the display device to display an enlarged display of the valid area, when the display device has statically displayed the circular sections.

Since the display device displays the enlarged display of the valid area, the player can easily comprehend the proceedings of a game. Particularly, as the player may be interested in only the valid area during the game, the slot machine can allow the player feel more interested in the game.

As described above, the present invention can provide an unconventional slot machine.

### BRIEF DESCRIPTION OF THE DRAWINGS

FIG. 1 is a perspective view illustrating an external appearance of a slot machine according to an embodiment of the present invention;

FIG. 2 is an enlarged front view illustrating a display area of the slot machine;

FIG. 3 is a block diagram illustrating an electrical configuration of a controller of the slot machine;

FIG. 4 is a block diagram illustrating an electrical configuration of a display controller of the slot machine;

FIG. 5 is a payout table showing the amount of game currency of the slot machine paid out;

FIG. 6 is a flow chart showing a process flow for the slot machine;

FIG. 7 is a schematic diagram illustrating Example 1 of a display area of the slot machine;

FIG. 8 is a schematic diagram illustrating Example 2 of a display area of the slot machine;

FIG. 9 is a schematic diagram illustrating Example 3 of a display area of the slot machine; and

FIG. 10 is a schematic diagram illustrating Example 4 of a display area of the slot machine.

### DETAILED DESCRIPTION OF THE INVENTION

An embodiment of the invention is now described with reference to the drawings.

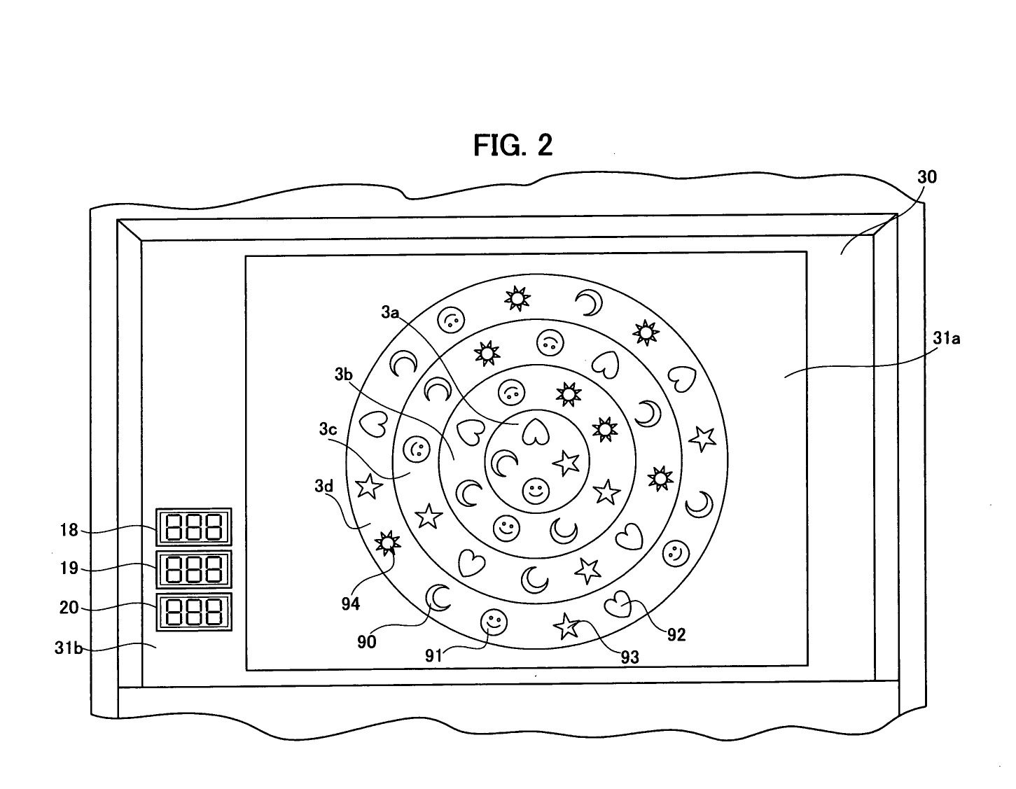

First, a description is given of an exemplary slot machine according to an embodiment of the invention with reference to FIGS. 2, and 7 to 9.

The slot machine according to the embodiment is a video slot machine having an image displaying device such as a liquid crystal display device to display images of various kinds of symbols for a game.

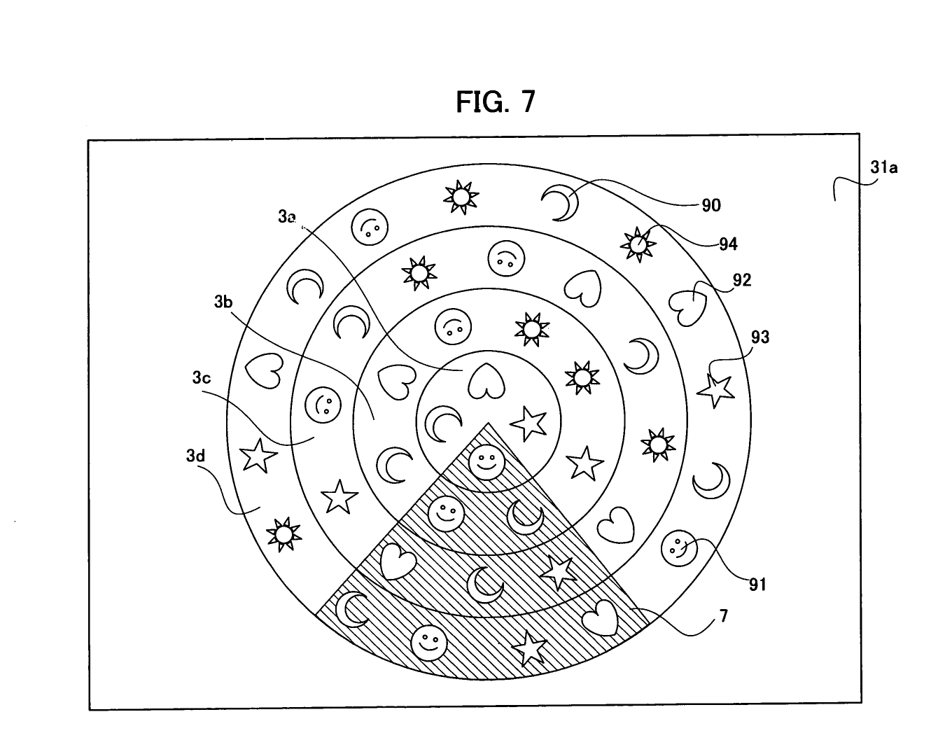

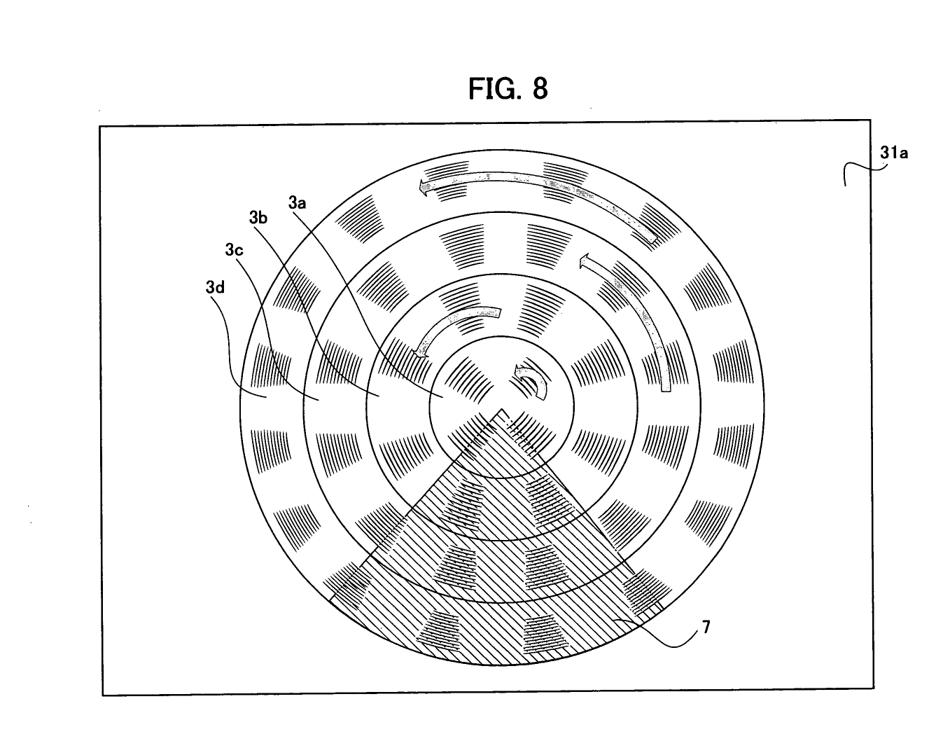

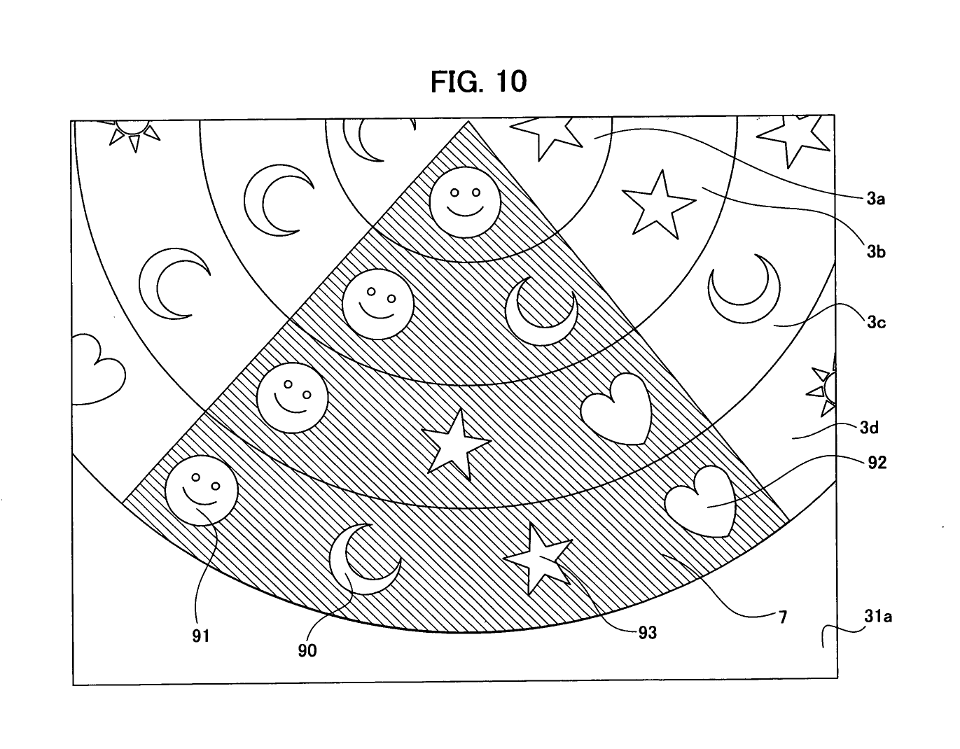

As shown in FIG. 2, a slot machine 10 includes a liquid crystal display device 30 with a first displaying surface 31a on which circular sections are displayed in the form of coaxial circles having different radii. As shown in FIGS. 7 to 10, the slot machine 10 displays a valid area 7 and areas other than the valid area 7 in different colors. The slot machine 10 according to the embodiment of the invention rotationally displays the circular sections around the axis aligned with the center of the coaxial circles (see FIG. 8), displays an enlarged display of the valid area 7 when the circular sections are statically displayed (see FIG. 10), and then provides the player with coins and the like according to the combination of symbols statically displayed in the valid area 7.

a. Construction of Slot Machine 10

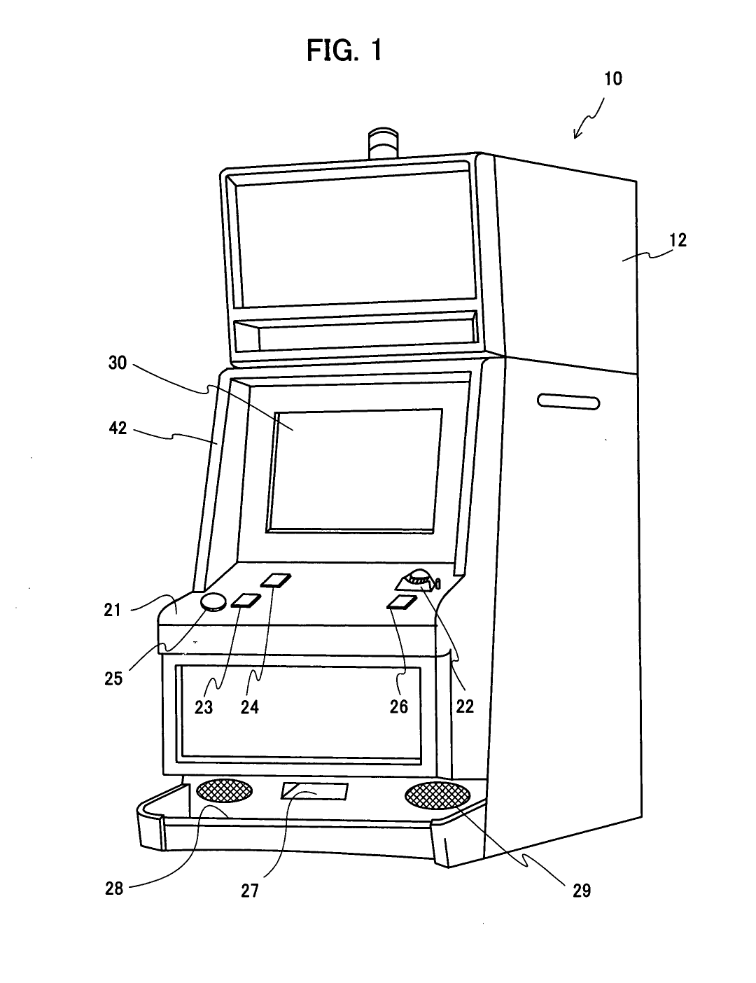

A Description is given of the slot machine 10 according to the embodiment of the present invention with reference to FIG. 1.

The slot machine 10 has a cabinet 12 and a main door 42.

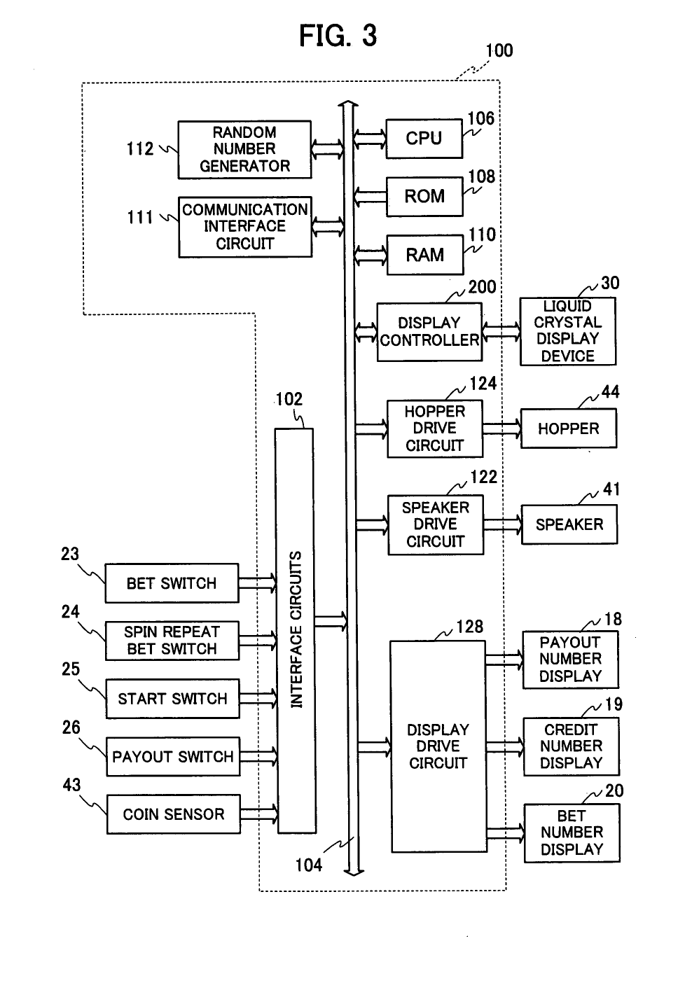

The cabinet 12, which has a surface open to a player, is installed in a certain place of a casino. A controller 100 for electrically controlling the slot machine 10 (see FIG. 3), and a hopper 44 (see FIG. 3) for controlling the storing and payout of coins (game media) are provided inside the cabinet 12.

The main door 42 covers the cabinet 12 so that the inside of the cabinet 12 is not seen from the outside. The main door 42 is attached to a left side of the cabinet 12 about an axis as seen from front, so that the door 42 swings about the axis in the forward and backward directions, and settles in one of selectable open and closed positions. The liquid crystal display device 30 is disposed substantially in the center of the main door 42.

The liquid crystal display device 30 displays images of the plurality of circular sections and various images associated with a game. A player proceeds with a game while looking at the various images displayed on the liquid crystal display device 30. The liquid crystal display device 30 is described in more detail later.

A substantially flat operation panel 21 is disposed under the liquid crystal display device 30. A coin insertion slot 22 for inserting coins into the slot machine 10 is disposed on the right side of the operation panel 21. On its left side are disposed a BET switch 23 and a spin repeat bet switch 24. A player uses the BET switch 23 to select the number of coins bet on a game. The player uses the spin repeat bet switch 24 so as to keep the number of coins bet in a subsequent game. In summary, the player determines the number of coins bet on one game by pushing one of the BET switch 23 and the spin repeat bet switch 24.

A start switch 25 is disposed on the left side of the BET switch 23 on the operation panel 21. At the start of each game, the start switch 25 receives an instruction for starting a game given by the player. Pushing one of the start switch 25 and the spin repeat bet switch 24 triggers the start of a game, starting a rotational display of the circular sections 3a to 3d.

A payout switch 26 is disposed adjacent to the coin insertion slot 22 on the operation panel 21. When a player pushes the payout switch 26, coins in the slot machine 10 are paid out through a coin payout opening 27 into a coin tray 28. Sound outlets 29, through which sound effects generated by speakers 41 (see FIG. 3) are conveyed to the outside of the cabinet 12, are disposed at both the right and left sides of the coin payout opening 27 over the coin tray 28.

The slot machine 10 according to the embodiment employs a coin as a game medium. It should be noted that the game medium is not limited to coins, but it may be alternatively possible to adopt any kind of game medium such as cash, a medal, a token, electronic money, a ticket, an IC card, and the like.

b. Construction of Liquid Crystal Display Device 30

A description is given of the liquid crystal display device 30 with reference to FIG. 2.

The liquid crystal display device 30 includes a publicly known liquid crystal display, and has a first displaying surface 31a and a second displaying surface 31b. The first displaying surface 31a displays the circular sections 3a, 3b, 3c and 3d. The second displaying surface 31b includes a payout number display 18, a credit number display 19, and a BET number display 20.

The circular sections 3a, 3b, 3c, and 3d, which are coaxially aligned in circles with different radii, are displayed on the first displaying surface 31a. On each of the circular sections 3a to 3d, symbols aligned in a circle including moon symbols 90, smile symbols 91, heart symbols 92, star symbols 93, and scatter symbols 94, are displayed. The aligned symbols on each of the circular sections 3a to 3d are rotationally displayed around the axis of the coaxial circles.

The payout number display 18 displays an amount of award to be paid out when the combination of symbols statically displayed on the first displaying surface 31a matches a predetermined combination. The credit number display 19 displays the credit number which the player currently possesses. The BET number display 20 displays the number of coins (a BET number), which represents the number of coins the player bets on a game. The displays 18 to 20 each include a seven-segment display. Alternatively, it may be possible to display the displays 18 to 20 in the form of images.

c. Electric Construction of Slot Machine 10

A description is given of the electric construction of the slot machine 10 with reference to FIG. 3.

A controller 100 of the slot machine 10 is a micro computer, which includes interface circuits 102, an input/output bus 104, CPU 106, ROM 108, RAM 110, communication interface circuit 111, random number generator 112, speaker drive circuit 122, hopper drive circuit 124, display drive circuit 128, and display controller 200.

The interface circuits 102 are electrically connected with the input/output bus 104, which carries out input and output of data signals and address signals for CPU 106.

The start switch 25 is electrically connected with the interface circuits 102. In the interface circuits 102, a start signal generated by the start switch 25 is transformed into a predetermined form of signal to be supplied to the input/output bus 104.

The BET switch 23, the spin repeat bet switch 24 and the payout switch 26 are also electrically connected with the interface circuits 102. In the interface circuits 102, a switching signal generated by each of these switches 23, 24 and 25 is transformed into a predetermined form of signal to be supplied to the input/output bus 104.

A coin sensor 43 is also electrically connected with the interface circuits 102. The coin sensor 43 detects coins inserted into the coin insertion slot 22, and is disposed at an appropriate position relative to the coin insertion slot 22. In the interface circuits 102, a sensing signal generated by the coin sensor 43 is transformed into a predetermined form of signal to be supplied to the input/output bus 104.

ROM 108 and RAM 110 are also electrically connected with the input/output bus 104.

When the start switch 25 accepts an instruction for starting a basic game, CPU 106 reads out a first game program so as to carry out a basic game. A first game program is programmed in the following manner. The first game program sends an instruction for rotationally displaying each of the circular sections 3a to 3d. Subsequently, the first game program sends an instruction for statically displaying each of the circular sections 3a to 3d. The first game program sends an instruction for paying out coins when the combination of symbols statically displayed matches a predetermined combination.

If three or more scatter symbols 93 are statically displayed in the valid area 7 (see FIG. 7) when the symbols on each of the circular sections 3a to 3d are statically displayed, CPU 106 reads out a second game program, initiating a bonus game. The second game program is programmed to send an instruction to cause a character to appear and act in a predetermined manner. A description is not given of the action in detail performed by the character in the bonus game.

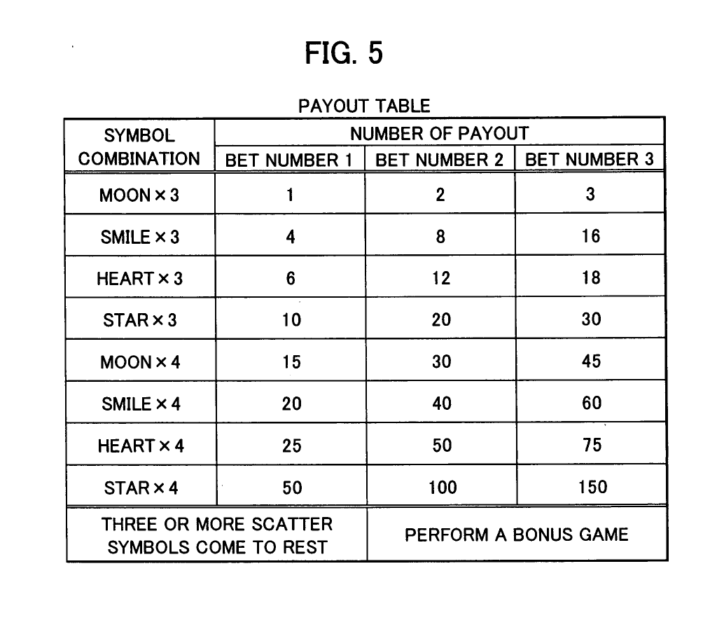

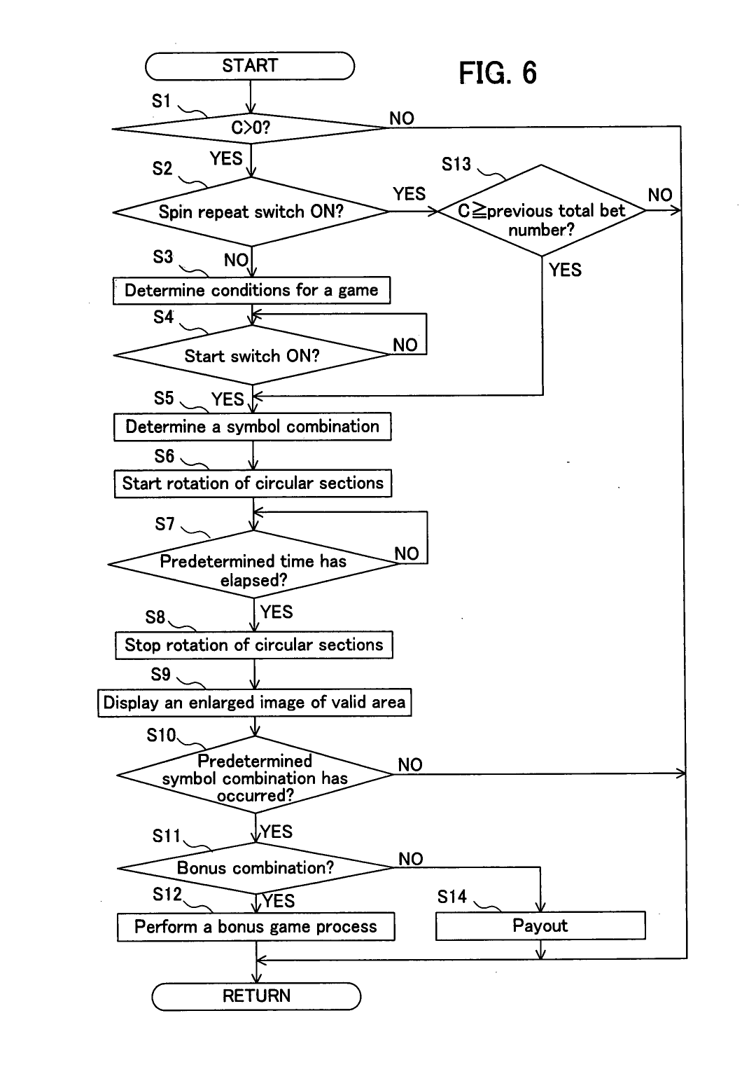

ROM 108 stores a control program to centrally control the slot machine 10, a computer program to carry out routines shown in FIG. 6 (hereinafter referred to as “routine program”), initial data to execute the control program, and various data tables. In this connection, the routine program includes the first game program, the second game program, and the like. The table shown in FIG. 5 and the like are examples of the data tables described above.

RAM 110 temporarily stores flags, variables and the like, which are used in the control program described above.

The communication interface circuit 111 is electrically connected with the input/output bus 104. The communication interface circuit 111 is for communicating with servers and the like through various communication networks including public telecommunication networks and LAN.

The random number generator 112 is also electrically connected with the input/output bus 104. The random number generator 112 generates random numbers in a predetermined range of “0” to “65535” (the sixteenth power of two minus one), for example. It may be alternatively possible that CPU 106 generates random numbers.

The display drive circuit 128, which drives the various displays 18 to 20 described above, is electrically connected with the input/output bus 104. CPU 106 controls the displays 18 to 20 through the display drive circuit 128 in response to game proceedings.

The speaker drive circuit 122 for the speakers 41 is also electrically connected with the input/output bus 104. CPU 106 reads out sound data stored in ROM 108, controlling transmission of the sound data to the speaker drive circuit 122 through the input/output bus 104. In this way, the speakers 41 generate predetermined sound effects.

The hopper drive circuit 124 for driving the hopper 44 is also electrically connected with the input/output bus 104. When CPU 106 receives a payout signal from the payout switch 26, CPU 106 controls transmission of a drive signal to the hopper drive circuit 124. Accordingly, the hopper 44 pays out coins such that the number of them is equivalent to the current number of coins remaining as credit, which is stored in a predetermined memory area of RAM 110.

The display controller 200 is also electrically connected with the input/output bus 104. CPU 106 generates an instruction for displaying an image according to the status and outcome of a game, outputting an instruction for displaying images to the display controller 200 through the input/output bus 104. When the display controller 200 receives the instruction from CPU 106, it generates a drive signal, outputting it to the liquid crystal display device 30. In this way, the liquid crystal display device 30 displays images of the circular sections 3a to 3d.

d. Electrical Construction of Display Controller 200

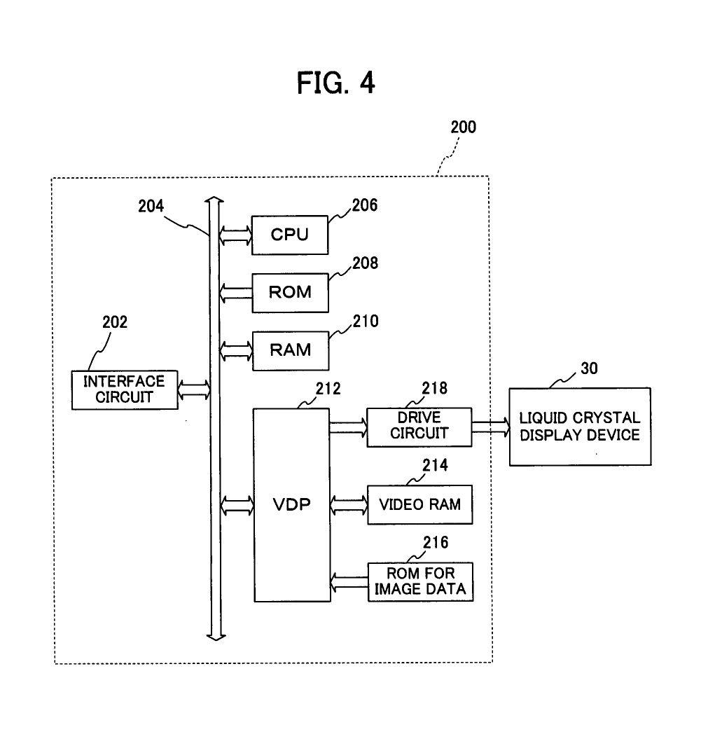

A description is given of the electric construction of the display controller 200 with reference to FIG. 4.

The aforementioned display controller 200 is a sub-microcomputer controlling image displaying processes. The controller 200 includes an interface circuit 202, input/output bus 204, CPU 206, ROM 208, RAM 210, VDP 212, video RAM 214, ROM 216 for image data, and drive circuit 218.

The interface circuit 202 is electrically connected with the input/output bus 204. An instruction for displaying an image generated by CPU 106 of the controller 100 is sent to the input/output bus 204 through the interface circuit 202. The input/output bus 204 conducts input and output of data signals and address signals for CPU 206.

ROM 208 and RAM 210 are also electrically connected with the input/output bus 204. ROM 208 stores a display controlling program which generates a drive signal to be sent to the liquid crystal display device 30 in response to the instruction for displaying an image sent from CPU 106 of the controller 100. On the other hand, RAM 210 stores flags and variables applied to the computer program for controlling display.

VDP 212 is also electrically connected with the input/output bus 204. VDP 212, which includes a so-called sprite circuit, screen circuit, and pallet circuit, is a processor which is able to perform versatile processing to display images on the liquid crystal display device 30. The video RAM 214 and ROM 106 for image data are electrically connected with VDP 212. The video RAM 214 stores image data in response to an instruction for displaying an image, which is given by CPU 106 of the controller 100. ROM 216 stores various image data, including image data of the circular sections and the symbols. Moreover, the drive circuit 218 that generates drive signals for the liquid crystal display device 30 is electrically connected with VDP 212.

CPU 206 reads out the image data of the symbols included in the circular sections 3a to 3d and the image data of the valid area 7 from ROM 216 in response to an instruction for displaying an image sent from CPU 106 of the controller 100. In addition, CPU 206 controls the video RAM 214 to store the abovementioned data into a predetermined memory area corresponding to the displaying position. In this way, CPU 206 supplies these data to the drive circuit 218 as displaying signals via VDP 212, so that the circular sections 3a to 3d and the valid area 7 are displayed on the first displaying area 31a. In addition, CPU 206 rewrites the image data of symbols to be stored in the video RAM 214 via VDP 212, so that the circular sections 3a to 3d are rotationally displayed on the first displaying surface 31a.

As explained above, it is understood that various processes described in the appended claims are executed by the controller 100, which includes ROM 108, CPU 106, RAM 110, and the display controller 200. ROM 108 stores computer programs for executing the routines described above. CPU 106 conducts various kinds of controls in accordance with the computer programs stored in ROM 108. RAM 110 serves as a working area for CPU 106. The display controller 200 controls driving of the liquid crystal display device 30. The processes executed by the display controller 200 may be, but are not necessarily, included in the processes described in the appended claims. The display controller 200 includes CPU 206, ROM 208, RAM 210, VDP 212, the video RAM 214, ROM 216 for image data, and the drive circuit 218. In other words, the controller 100 serves as an example of a game controller. This will be made more definite by the following description on an operation of the slot machine 10 with reference to FIG. 6.

e. Payout Table

FIG. 5 shows a payout table applied to a basic game. This table registers the number of coins to be paid out (an amount of payout), correlated with the number of coins (BET number) bet on a combination of symbols during a game.

The combination of symbols shown in FIG. 5 represents a combination of symbols statically displayed in the valid area 7 (see FIG. 7). For example, three consecutive star symbols 93 statically displayed in the valid area 7 are referred to as a symbol combination of “star×3”. When the star symbols 93 are statically displayed on the three circular sections adjacent to each other, the combination is referred to as “star×3”. More specifically, when three star symbols 93 are statically displayed in the circular sections 3a, 3b and 3c, as well as in the circular sections in 3b, 3c and 3d, the combination is referred to as “star×3”. In contrast, when three star symbols 93 are statically displayed in the circular sections not adjacent to each other, 3a, 3c and 3d, or 3a, 3b and 3d for example, the combination is not referred to as “star×3”. According to this payout table, ten coins are paid out for the BET number “1”, twenty coins for the BET number “2”, and thirty coins for the BET number “3”.

In addition, according to this payout table, when three or more scatter symbols 94 have been statically displayed in the valid area 7, the slot machine 10 starts a bonus game. More specifically, the slot machine 10 carries out a bonus game even if the three scatter symbols are not consecutively displayed: for example, one scatter symbol in the circular section 3b, and two scatter symbols in the circular section 3c. Various kinds of games may be adopted as a bonus game. In the embodiment of the present invention, a free game is adopted as a bonus game. The free game gives a player an opportunity to play a predetermined number of basic games without betting, and provides coins paid out according to a combination of symbols.

f. Operation of Slot Machine 10

FIG. 6 shows routines for controlling the slot machine 10 executed by the controller 100. The main program of the slot machine 10 executed in advance calls a series of routines in FIG. 6 at predetermined timing, and executes them.

In the following description, the slot machine 10 has been in operation in advance, and variables used by CPU 106 of the controller 100 have been initialized to predetermined values. Accordingly, the slot machine 10 is in normal operation.

CPU 106 of the controller 100 determines whether or not coins inserted by a player remain as credit (step S1). More specifically, CPU 106 reads out a credit number C stored in RAM 110, executing processes according to the credit number C. When the credit number C equals “0” (NO in step S1), CPU 106 terminates the routine without executing any process, because it cannot start a game. When the credit number C is not less than “1” (YES in step S1), CPU 106 determines that coins remain as credit, moving the process to step S2.

In step S2, CPU 106 determines whether or not a pushing action has been applied to the spin bet repeat switch 24. When the switch 24 has been pushed and CPU 106 receives a signal from the switch 24 (YES in step S2), CPU 106 moves the process to step S13. On the other hand, when CPU 106 does not receive a signal from the switch 24 after a predetermined lapse of time (NO in step S2), CPU 106 determines that the switch 24 has not been pushed and moves the process to step S3.

In step S3, CPU 106 determines conditions for a game. More specifically, receiving signals indicative of action for the BET switch 23, CPU 106 determines a BET number and a predetermined area of the circular sections 3a to 3d as a valid area 7. Subsequently, CPU 106 moves the process to step S4.

In step S3, receiving signals indicative of action for the BET switch 23, CPU 106 controls RAM 110 to store the BET number in accordance with the number of received signals. CPU 106 reads out the credit number C stored in RAM 110, subtracting the abovementioned BET number from the read-out credit number C. CPU 106 controls RAM 110 to store the resulting value. In addition, CPU 106 determines a circular sector occupying substantially a quarter of the circular sections 3a to 3d as a valid area 7, controlling RAM 110 to store the valid area 7.

As described above, since the valid area 7 shaped in a circular sector is fitted with the circular sections, the player can identify the valid area 7 more intuitively, which helps the player more easily comprehend the proceedings of a game.

The size of a circular sector is not restricted to substantially a quarter of the circular sections 3a to 3d, but it is alternatively possible to adopt another size by changing the central angle of the circular sector in the valid area 7 according to the BET number. More specifically, the central angle of the circular sector is determined for a BET number equal to 3, such that one symbol can be displayed in the circular section 3a, two symbols in the circular section 3b, three symbols in the circular section 3c, and four symbols in the circular section 3d. On the other hand, it is possible to determine the central angle of the circular sector for a BET number equal to 1, such that one symbol can be displayed in the circular section 3a, one symbol in the circular section 3b, two symbols in the circular section 3c, and three symbols in the circular section 3d.

In this way, it is possible to adjust the probability of winning an award to increase in proportion to the BET number given by the player, by determining the central angle of the circular section in the valid area 7 according to the BET number. This increases the enjoyment of a player through making a strategy according to the size of the valid area 7.

In step S4, CPU 106 stands by, monitoring a signal coming from the start switch 25. When CPU 106 receives a signal indicative of pushing action for the start switch 25 (YES in step S4), CPU 106 determines that the start switch 25 has been turned on, moving the process to step S5. A spin input provided by an action for the spin repeat bet switch 24 in step S2, or an action for the start switch 25 in step S4, allows a game to start.

On the other hand, in step S13, CPU 106 determines whether or not the credit number C is equal to or greater than the total bet number in a previous game. In other words, CPU 106 determines whether or not it can start a game in response to a pushing action applied to the spin repeat bet switch 24. More specifically, when the spin repeat bet switch 24 is pushed and a signal coming from the switch 24 enters CPU 106, CPU 106 reads out the credit number C and the BET number in the previous game. CPU 106 selects a subsequent process according to whether or not the current credit number C is equal to or greater than the total bet number for the previous game. When CPU 106 determines that the credit number C is less than the total bet number (NO in step S13), CPU 106 terminates the routine without any process, because it cannot start a game. On the other hand, when CPU 106 determines that the credit number C is equal to or greater than the total bet number for the previous game (YES in step S13), CPU 106 subtracts the total bet number for the previous game from the credit number C, controlling RAM 110 to store the resulting value. Subsequently, CPU 106 moves the process to step S5.

In step S5, CPU 106 performs a process for determining a combination of symbols. More specifically, CPU 106 sends an instruction for generating random numbers to the random number generator 112. CPU 106 extracts a number from a predetermined range of random numbers (e.g., “0” to “65535”) generated by the random number generator 112. CPU 106 controls the RAM 110 to store the extracted random number. In this embodiment, the random number generator 112 displaced outside CPU 106 generates random numbers. However, the present invention is not restricted to this setup. It may be alternatively possible that CPU 106 generates random numbers without the random number generator 112.

CPU 106 reads out the table for determining symbol combinations and the table of combinations entitled to awards (neither shown) stored in ROM 108, controlling RAM 110 to store these tables. The table for determining symbol combinations correlates a symbol combination with random numbers, and has the information about probability for determining the symbol combination. In addition, the table of combinations entitled to awards has the information about combinations of symbols statically displayed to be awarded.

CPU 106 reads out the table for determining symbol combinations, determining a symbol combination for a particular game with the random numbers stored in RAM 110 as parameters. CPU 106 controls the RAM 110 to store the determined symbol combination. After determining the symbol combination, CPU 106 determines the information about the symbol combination to be statically displayed corresponding to the symbol combination determined above, with reference to the table of combinations entitled to awards. CPU 106 controls RAM 110 to store this information into a predetermined memory area.

CPU 106 determines whether or not the symbol combination coincides with a particular symbol combination (e.g., “star×3” and the like). When CPU 106 determines a coinciding combination, CPU 106 activates an award flag indicating the particular symbol combination. CPU 106 controls RAM 110 to store the activated award flag into a predetermined memory area. On the other hand, when the symbol combination coincides with a blank, CPU does not activate the award flag. Subsequently, CPU 106 moves the process to step S6.

In step S6, CPU 106 starts rotation of the circular sections 3a to 3d. More specifically, upon CPU 106 sending an instruction for displaying images, CPU 206 sequentially rewrites the symbol image data, which is to be stored in RAM 214 via VDP 212, so as to control the circular sections 3a to 3d to be rotationally displayed. Subsequently, CPU 106 moves the process to step S7.

After starting a rotational display of the circular sections 3a to 3d, CPU 106 stands by until a predetermined time has elapsed (step S7). When the predetermined time has elapsed (YES in the process of step S7), CPU 106 automatically controls the respective circular sections 3a to 3d to be statically displayed (step S8). More specifically, upon CPU 106 sending an instruction for displaying an image, CPU 206 generates a symbol image data via VDP 212 based on the information about the symbol combination to be statically displayed, which has been determined in step S5. CPU 106 controls video RAM 214 to store this symbol image data, supplying it to the driving circuit 218 as a display signal. Subsequently, CPU 106 moves the process to step S9.

In step S9, CPU 106 controls an enlarged display of the valid area 7. More specifically, upon CPU 106 sending an instruction for displaying an image, CPU 206 generates an image data to be enlarged via VDP 212, with the symbol image data for the symbols which are displayed statically and stored in the video RAM 214, and the valid area 7 stored in RAM 110. CPU 206 controls the video RAM 214 to store the generated image data, supplying it to the driving circuit 218 as a display signal. Subsequently, CPU 106 moves the process to step S10.

In step S10, CPU 106 determines whether or not a predetermined symbol combination has occurred. More specifically, CPU 106 determines the occurrence based on the state of an award flag stored in the abovementioned RAM 110. When the award flag is not activated (NO in the process of step S10), CPU 106 terminates the process. On the other hand, when the award flag is activated (YES in the process of step S10), CPU 106 moves the process to step S11.

In step S11, CPU 106 determines whether or not the symbol combination coincides with a bonus combination. More specifically, CPU 106 determines the coinciding combination based on the type of an award flag stored in the predetermined area of RAM 110. When the activated award flag coincides with the flag indicating “bonus” (YES in the process of step S11), CPU 106 moves the process to step S12. On the other hand, when the activated award flag coincides with a flag other than the flag indicating “bonus” (NO in the step of step S11), CPU 106 moves the process to step S14. It should be noted that the bonus combination represents a combination including three or more scatter symbols 94 statically displayed in the valid area 7 (see FIG. 5).

In step S11, CPU 106 conducts the bonus game process, terminating the routine.

On the other hand, in step S13, CPU 106 controls payout of a predetermined number of coins corresponding to the abovementioned award other than “bonus”. More specifically, CPU 106 calculates the number of coins to be paid out with reference to the payout table (see FIG. 5). Reading out the credit number stored in RAM 110, CPU 106 adds the number of coins paid out to the read-out credit number, controlling the RAM 110 to store the resulting summation. In addition, CPU 106 controls the credit number display 19 to display the stored value. Upon finishing the process in step S13, CPU 106 terminates the routine.

g. Example of Display for Circular Sections 3a to 3d

A description is given of an example of the circular sections 3a to 3d displayed on the first displaying surface 31a with reference to FIGS. 7 to 10.

FIG. 7 illustrates an example of a display when game conditions are set in response to insertion of coins by a player. As shown in FIG. 7, the circular sections 3a to 3d aligned in coaxial circles with different radii are displayed on the first displaying surface 31a. The symbols 90 to 94 placed at regular intervals and the valid area 7 are displayed on the circular sections 3a to 3d. In FIG. 7, the circular sections 3a to 3d and the valid area 7 are displayed in different colors so as to distinguish the valid area 7 from other areas.

FIG. 8 illustrates an example of a display when the circular sections 3a to 3d are rotationally displayed. When a player manipulates the start switch 25, a rotational display of the circular sections 3a to 3d starts (step S6 in FIG. 6). It should be noted that the valid area 7 is statically displayed.

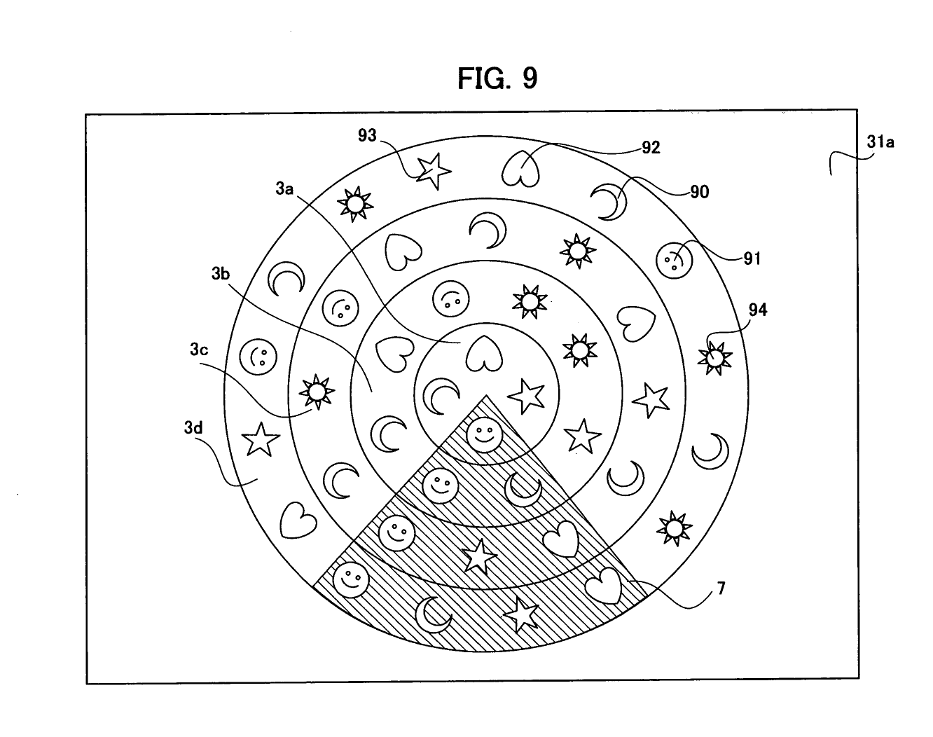

FIG. 9 illustrates an example of the statically displayed circular sections 3a to 3d. When a predetermined time has elapsed after the start of the rotational display of the circular sections 3a to 3d, they are statically displayed (step S8 in FIG. 6). The circular sections 3a to 3d are arranged in such a manner that the combination of symbols in agreement with that determined in step S5 of FIG. 6 is statically displayed in the valid area 7.

FIG. 10 illustrates an example of an enlarged display of the valid area 7. When the circular sections 3a to 3d are statically displayed, an enlarged display of the valid area 7 is displayed on the first displaying surface 31a (step S9 in FIG. 6). As shown in FIG. 10, it is possible to know that a symbol combination of “smile×4” is formed by the smile symbols 91 statically displayed on the circular section 3a, and the left sides of the circular sections 3b, 3c and 3d in the valid area 7 (see FIG. 5).

As described above, the game according to the embodiment proceeds with a new type of the circular sections 3a to 3d of coaxial circles with different radii instead of linear sections. Accordingly, since the player can enjoy a novel and unconventional game, the slot machine can increase the enjoyment factor of the game.

In addition, the slot machine according to the embodiment does not require the player to comprehend complicated pay lines, but it is sufficient for the player to know the valid area 7 while the game is proceeding. This is due to the fact that the game proceeds with the combination of symbols statically displayed in the valid area 7. It should be noted that the player can intuitively know the proceedings of the game since the valid area 7 is displayed in colors, differing from the circular sections 3a to 3d.

Furthermore, since the valid area 7 is displayed in an enlarged manner when the circular sections 3a to 3d are statically displayed, the player can know the proceedings of the game more easily. As shown in FIG. 10, it is possible to easily recognize that the symbol combination “smile×4” is formed. Since the player may be interested in only the valid area 7 during the game, the slot machine can allow the player feel more interested in the game.

The slot machine according to the embodiment, in which different colors are used for the valid area 7 and the circular sections 3a to 3d, allows the player to identify the valid area 7. The present invention is not restricted to this. It may be possible to adopt other ways to distinguish the valid area 7 from other areas, such as a boundary framing image, so long as they allow the player to identify the valid area 7.

In the slot machine according to the embodiment, all of the circular sections 3a to 3d are configured to be rotationally displayed counterclockwise. The present invention is not restricted to this. It may be alternatively possible to allow the circular sections 3a to 3d to be rotationally displayed clockwise, or some of them counterclockwise and the others clockwise.

Since this alternative provides the player with an unconventional aspect of enjoyment in the game, in which the circular sections 3a to 3d are rotationally displayed in different directions, the slot machine 10 can increase the enjoyment factor of the game.

In addition, it may be possible to determine the rotational directions of the circular sections 3a to 3d according to the symbol combination set in step S5 of the FIG. 6. For example, it may be possible to determine the rotational directions of the circular sections 3a to 3d to be different from normal cases if the bonus combination occurs in step S5 of FIG. 6. This allows the player to expect a bonus game to start if the rotational directions of the circular sections 3a to 3d change, which can increase the enjoyment factor of the game.

While a description has been given of the present invention, it is not restricted to the embodiment described above.

For example, although the description has been given of a simulated reel slot machine, it may be possible to apply the present invention to a mechanical reel slot machine.

What is claimed is:

1. A slot machine comprising:
a display device for dynamically and statically displaying a plurality of circular sections aligned in coaxial circles with different radii, each section displaying a plurality of game symbols; and
a controller configured with the logic to:
(a) determine a circular sector coaxial with the coaxial circles as a valid area;
(b) control the display device to display the valid area and areas other than the valid area in different colors;
(c) control the display device to display the circular sections in a rotational motion around an axis aligned with the center of the coaxial circles, in response to an instruction for starting a game given by a player;
(d) control the display device to statically display the rotationally displayed circular sections; and
(e) provide an award to the player when the display device has statically displayed predetermined symbols on a predetermined number of the circular sections within the valid area.

2. A slot machine according to claim 1, wherein the controller controls the display device to rotationally display at least one of the circular sections in a predetermined direction, and other sections in the opposite direction.

3. A slot machine according to claim 1, wherein the controller is further configured with the logic to: (f) control the display device to display an enlarged display of the valid area, when the circular sections have been statically displayed.

4. A slot machine comprising:
a display device for dynamically and statically displaying a plurality of circular sections aligned in coaxial circles with different radii, each section displaying a plurality of game symbols; and
a controller configured with the logic to:
(a) determine a circular sector coaxial with the coaxial circles as a valid area;
(b) control the display device to display the valid area and areas other than the valid area in different colors;
(c) control the display device to display at least one of the circular sections in a rotational motion of a predetermined direction around an axis aligned with the center of the coaxial circles, and other sections in a rotational motion of the opposite direction around the axis, in response to an instruction for starting a game given by a player;
(d) control the display device to statically display the rotationally displayed circular sections;
(e) control the display device to display an enlarged display of the valid area, when the circular sections have been statically displayed; and
(f) provide an award to the player when the display device has statically displayed predetermined symbols on a predetermined number of the circular sections within the enlarged display of the valid area displayed on the display device.

5. A method for a controller controlling a game of a slot machine having a display device for dynamically and statically displaying a plurality of circular sections, each displaying a plurality of game symbols, the method comprising the steps of:
(a) controlling the display device to display a plurality of circular sections aligned in coaxial circles with different radii;
(b) determining a circular sector coaxial with the coaxial circles as a valid area;
(c) controlling the display device to display the valid area and areas other than the valid area in different colors;
(d) controlling the display device to display the circular sections in a rotational motion around an axis aligned with the center of the coaxial circles, in response to an instruction for starting a game given by a player;
(e) controlling the display device to statically display the rotationally displayed circular sections; and
(f) providing an award to the player when the display device has statically displayed predetermined symbols on a predetermined number of the circular sections within the valid area.

6. A method according to claim 5, wherein the controller controls the display device to rotationally display at least one of the circular sections in a predetermined direction, and other sections in the opposite direction in the step (d).

7. A method according to claim 5, further comprising the step of:
(g) controlling the display device to display an enlarged display of the valid area, when the circular sections have been statically displayed.

8. A method for a controller controlling a game of a slot machine having a display device for dynamically and statically displaying a plurality of circular sections, each displaying a plurality of game symbols, the method comprising the steps of:
(a) controlling the display device to display a plurality of circular sections aligned in coaxial circles with different radii;
(b) determining a circular sector coaxial with the coaxial circles as a valid area;
(c) controlling the display device to display the valid area and areas other than the valid area in different colors;
(d) controlling the display device to display at least one of the circular sections in a rotational motion of a predetermined direction around an axis aligned with the center of the coaxial circles, and to display other sections in a rotational motion of the opposite direction around the axis, in response to an instruction for starting a game given by a player;
(e) controlling the display device to statically display the circular sections rotationally displayed in the step (d);
(f) controlling the display device to display an enlarged display of the valid area, when the circular sections have been statically displayed; and
(g) providing an award to the player when the display device has statically displayed predetermined symbols on a predetermined number of the circular sections within the enlarged display of the valid area.
